(19) United States
(12) Patent Application Publication
(10) Pub. No.: US 2026/0188744 A1
(43) Pub. Date: Jul. 2, 2026

(54) LITHIUM SECONDARY BATTERY

(71) Applicant: TEIJIN LIMITED, Osaka-shi, Osaka (JP)

(72) Inventors: Naoaki YABUUCHI, Yokohama-shi, Kanagawa (JP); Satoshi NISHIKAWA, Osaka-shi, Osaka (JP)

(73) Assignee: TEIJIN LIMITED, Osaka-shi, Osaka (JP)

(21) Appl. No.: 19/123,882

(22) PCT Filed: Oct. 27, 2023
(86) PCT No.: PCT/JP2023/038993

§ 371 Date: Apr. 24, 2025

(30) Foreign Application Priority Data
Oct. 31, 2022 (JP) 2022-175127

(51) Int. Cl. H01M 10/0568; H01M 4/485; H01M 4/525; H01M 10/0525; H01M 10/0569; H01M 10/42

(52) U.S. Cl. CPC H01M 10/0568; H01M 4/485; H01M 4/525; H01M 10/0525; H01M 10/0569; H01M 10/4235

(57) ABSTRACT

A lithium secondary battery has a positive electrode, a negative electrode, an electrolyte solution, and a separator. The negative electrode is operated by dissolution and precipitation of metallic lithium, and the electrolyte solution contains a nonaqueous solvent and a lithium salt and has a lithium salt concentration of 3.0 mol/L or more. The separator has a polyolefin microporous film and a porous layer provided on one side or both sides of the polyolefin microporous film and containing a wholly aromatic polyamide.

### TECHNICAL FIELD

The present disclosure relates to a lithium secondary battery.

### BACKGROUND ART

For the purpose of improving the heat resistance of a secondary battery, a separator having a porous layer containing a heat-resistant resin such as polyamides and a secondary battery having the separator have been developed.

For example, PTL 1 discloses a lithium ion battery using a porous film containing an aromatic polyamide as a separator.

For example, PTL 2 discloses a secondary battery having a separator having a heat-resistant layer containing a polyamide or the like.

For example, PTL 3 discloses a separator for a storage device having a heat-resistant porous layer containing a wholly aromatic polyamide or the like.

A high salt concentration electrolyte solution having a high lithium salt concentration has been developed for a secondary battery.

For example, PTL 4 discloses a nonaqueous electrolyte solution having a molar ratio of a lithium imide salt to a solvent of 1:0.8 to 1:2.0.

For example, PTL 5 discloses an electrolyte solution containing 3 mol or less of a nonaqueous solvent with respect to 1 mol of a lithium salt.

### CITATION LIST

### Patent Literature

PTL 1: JP2015-060724A
PTL 2: JP2013-222582A
PTL 3: WO2021/210318
PTL 4: JP2019-160723A
PTL 5: WO2013/146714

### SUMMARY OF INVENTION

### Technical Problem

A lithium secondary battery is a secondary battery having a negative electrode that is operated by dissolution and precipitation of metallic lithium. The lithium secondary battery can theoretically achieve an energy density exceeding that of a lithium ion secondary battery. When a high salt concentration electrolyte solution having a high lithium salt concentration is applied to a lithium secondary battery, a lithium secondary battery having a high energy density and the advantages of a high salt concentration electrolyte solution is obtained. However, it has been difficult to put such a lithium secondary battery into practical use for the following reasons.

In the lithium secondary battery, metallic lithium precipitated in a dendritic manner (referred to as “lithium dendrite”) is sometimes generated on the negative electrode by repeating the charging process, which is a precipitation reaction. The generation of lithium dendrites means deformation of the negative electrode and deteriorates the cycle characteristics of the secondary battery. In addition, when lithium dendrites grow and reach the positive electrode, a short circuit occurs in the battery.

A high salt concentration electrolyte solution generally has a high viscosity, and the type of the separator into which the high salt concentration electrolyte solution can permeate has been limited. A single-layer polyolefin microporous film, which is widely used as the separator of a battery, is not suitable for the separator of a secondary battery having a high salt concentration electrolyte solution because the high salt concentration electrolyte solution does not permeate easily. On the other hand, since a glass fiber nonwoven fabric has a relatively large pore diameter, a high salt concentration electrolyte solution can permeate, and the glass fiber nonwoven fabric can be applied as the separator of a secondary battery having a high salt concentration electrolyte solution.

When a separator having a relatively large pore diameter such as a glass fiber nonwoven fabric is used, however, lithium dendrites are likely to be generated and to grow on the electrode. When a glass fiber nonwoven fabric is applied to a lithium secondary battery, the generation and the growth of lithium dendrites on the negative electrode are difficult to suppress, deterioration of the cycle characteristics is remarkable, and a risk of a short circuit of the battery increases.

The present disclosure has been made under the above circumstances.

An object of the present disclosure is to provide a lithium secondary battery in which lithium dendrites are not easily generated and which has excellent cycle characteristics, and a problem thereof is to achieve the object.

### Solution to Problem

Specific solutions to the problem include the following embodiments.

<1>

A lithium secondary battery having:
a positive electrode;
a negative electrode that is operated by dissolution and precipitation of metallic lithium;
an electrolyte solution containing a nonaqueous solvent and a lithium salt and having a lithium salt concentration of 3.0 mol/L or more; and
a separator having a polyolefin microporous film and a porous layer provided on one side or both sides of the polyolefin microporous film and containing a wholly aromatic polyamide.
   <2>

The lithium secondary battery according to <1> in which the lithium salt contains at least one selected from the group consisting of a sulfonamide lithium salt and a sulfonimide lithium salt.

<3>

The lithium secondary battery according to <1> or <2> in which the negative electrode has a metallic lithium layer.

<4>

The lithium secondary battery according to <1> or <2> in which the negative electrode has a current collector in which metallic lithium is precipitated on a surface thereof.

<5>

The lithium secondary battery according to any one of <1> to <4> in which the positive electrode has an active material layer containing a lithium-containing active material that electrochemically dopes and dedopes lithium.

<6>

The lithium secondary battery according to any one of <1> to <5> in which the separator has the porous layer on both sides of the polyolefin microporous film.

<7>

The lithium secondary battery according to any one of <1> to <6> in which the wholly aromatic polyamide contains a meta-type wholly aromatic polyamide.

<8>

The lithium secondary battery according to any one of <1> to <7> in which the porous layer further contains inorganic particles.

<9>

The lithium secondary battery according to <8> in which the inorganic particles contain metal sulfate particles.

<10>

The lithium secondary battery according to <8> or <9> in which the average primary particle diameter of the inorganic particles is 0.3 μm or less.

### Advantageous Effects of Invention

According to the present disclosure, a lithium secondary battery in which lithium dendrites are not easily generated and which has excellent cycle characteristics is provided.

### BRIEF DESCRIPTION OF DRAWINGS

FIG. 1 The charge-discharge curves of the two-electrode cells of Reference Example 1 and Reference Example 2.

FIG. 2 The charge-discharge curves of the two-electrode cells of Reference Example 2, Reference Example 3, and Reference Example 4.

FIG. 3 A graph showing the cycle characteristics of the two-electrode cells of Reference Example 2, Reference Example 3, and Reference Example 4.

FIG. 4 The charge-discharge curves of the two-electrode cells of Example 1 and Comparative Example 1.

FIG. 5 Graphs showing the cycle characteristics of the two-electrode cells of Example 1 and Comparative Example 1.

FIG. 6 The charge-discharge curves of the two-electrode cells of Example 2 and Comparative Example 2.

FIG. 7 A graph showing the cycle characteristics of the two-electrode cells of Example 2 and Comparative Example 2.

FIG. 8 Graphs showing the charge-discharge curves and the cycle characteristics of the two-electrode cells of Example 3 and Comparative Example 3.

### DESCRIPTION OF EMBODIMENTS

Hereinafter, embodiments of the present disclosure will be explained. The explanation and the Examples illustrate the embodiments but do not limit the scope of the embodiments.

In the present disclosure, “A and/or B” is synonymous with “at least one of A and B”. That is, “A and/or B” means that it may be only A, may be only B, or may be a combination of A and B.

In the present disclosure, a numerical range denoted using “to” represents the range inclusive of the numerical values written before and after “to” as the minimum value and the maximum value.

Regarding stepwise numerical ranges designated in the present disclosure, an upper or lower limit set forth in a numerical range may be replaced by an upper or lower limit of another stepwise numerical range described. Besides, an upper or lower limit set forth in a numerical range of the numerical ranges designated in the present disclosure may be replaced by a value indicated in the Examples.

In the present disclosure, the term “process” includes not only an independent process but also a process which is not clearly distinguished from other processes but achieves the purpose thereof.

In the present disclosure, when an embodiment is explained referring to the drawings, the configuration of the embodiment is not limited to the configuration illustrated in the drawings.

In the present disclosure, when the amount of each component in a composition is referred to and when a plurality of types of substances corresponding to a component are present in the composition, the total amount of the plurality of types of substances present in the composition is meant unless otherwise specified.

In the present disclosure, a plurality of types of particles corresponding to each component may be included. When a plurality of types of particles corresponding to a component are present in a composition, the particle diameter of the component means the value of the mixture of the plurality of types of particles present in the composition unless otherwise specified.

In the present disclosure, MD (Machine Direction) means the longitudinal direction of the polyolefin microporous film and the separator produced in a long shape, and TD (Transverse Direction) means a direction orthogonal to MD in the surface direction of the polyolefin microporous film and the separator. In the present disclosure, TD is also referred to as “width direction”.

In the present disclosure, when the stacking relationship of the layers constituting the separator is expressed by “upper” and “lower”, the layer closer to the polyolefin microporous film is referred to as “lower”, and the layer farther from the polyolefin microporous film is referred to as “upper”.

### <Lithium Secondary Battery>

The lithium secondary battery of the present disclosure has a positive electrode, a negative electrode, an electrolyte solution, and a separator.

The negative electrode that the lithium secondary battery of the present disclosure has is a negative electrode that is operated by dissolution and precipitation of metallic lithium.

The electrolyte solution that the lithium secondary battery of the present disclosure has is an electrolyte solution containing a nonaqueous solvent and a lithium salt and having a lithium salt concentration of 3.0 mol/L or more.

The separator that the lithium secondary battery of the present disclosure has is a separator having a polyolefin microporous film and a porous layer provided on one side or both sides of the polyolefin microporous film and containing a wholly aromatic polyamide. Hereinafter, the separator is also referred to as “separator (A)”, and the porous layer containing a wholly aromatic polyamide is also referred to as “porous layer (A)”.

The porous layer (A) contains a wholly aromatic polyamide. The wholly aromatic polyamide contains a large amount of polar groups and is thus presumed to exhibit high affinity with a high salt concentration electrolyte solution. Therefore, the high salt concentration electrolyte solution permeates into the separator (A) having the porous layer (A).

A high salt concentration electrolyte solution can be employed in the lithium secondary battery of the present disclosure because the separator (A) is included.

The polyolefin microporous film and the porous layer (A) of the separator (A) are a film and a layer having a smaller pore diameter and higher uniformity of the pore diameter than those of a glass fiber nonwoven fabric. That is, the porous structure of the separator (A) is denser than that of the glass fiber nonwoven fabric. In a negative electrode to which the separator (A) having a dense porous structure faces, lithium dendrites are not easily generated.

Because the lithium secondary battery of the present disclosure has the separator (A), lithium dendrites are not easily generated, and the cycle characteristics are excellent.

Hereinafter, the configuration of the lithium secondary battery of the present disclosure will be explained in detail.

### [Positive Electrode]

The positive electrode has, for example, a current collector and a positive electrode active material layer disposed on one side or both sides of the current collector.

The current collector of the positive electrode is preferably a metal foil. Examples of the metal foil include an aluminum foil, a titanium foil, a stainless steel foil, and the like. The thickness of the current collector of the positive electrode is preferably 5 μm to 20 μm.

The positive electrode active material layer preferably contains a positive electrode active material and a resin. The positive electrode active material layer may further contain a conductive auxiliary agent.

The positive electrode active material is preferably a lithium-containing active material that electrochemically dopes and dedopes lithium. Examples of the lithium-containing active material include lithium-containing transition metal oxides and metal phosphates. Examples of the lithium-containing transition metal oxides and the metal phosphates include LiCoO₂, LiCoPO₄, LiCO_{1/2}Ni_{1/2}O₂, LiNiO₂, Li_{0.96}NiO₂, LiNiPO₄, LiNi_{1/2}Mn_{1/2}O₂, LiNi_{0.5}Mn_{1.5}O₄, LiCO_{1/3}Ni_{1/3}Mn_{1/3}O₂, LiCo_{0.2}Ni_{0.4}Mn_{0.4}O₂, LiMn₂O₄, Li₂MnO₃, LiMnPO₄, LiFeO₂, LiFePO₄, LiAl_{1/4}Ni_{3/4}O₂, Li₄Ti₅O₁₂, Li_{8/7}Ti_{2/7}V_{4/7}O₂, Li_{1.1}Nb_{0.1}Mn_{0.8}O₂, Li₂MoO₄, and the like. One thereof may be used alone, or a mixture thereof may be used.

Examples of the resin include polyvinylidene fluoride type resin, an alginate, and the like. One thereof may be used alone, or a mixture thereof may be used.

Examples of the conductive auxiliary agent include carbon materials such as acetylene black, Ketjen black, and carbon fibers. One thereof may be used alone, or a mixture thereof may be used.

### [Negative Electrode]

The negative electrode is a negative electrode that is operated by dissolution and precipitation of metallic lithium. The negative electrode is preferably one of the form (1) and the form (2) below.

Form (1): A negative electrode having a metallic lithium layer.

Form (2): A negative electrode having a current collector in which metallic lithium is precipitated on a surface thereof.

### —Form (1)—

The negative electrode of the form (1) has, for example, a current collector and a metallic lithium layer disposed on one side or both sides of the current collector.

The current collector in the form (1) is preferably a metal foil. Examples of the metal foil include a copper foil, a silver foil, a stainless steel foil, a palladium foil, and the like. The current collector in the form (1) is preferably a copper foil. The thickness of the current collector in the form (1) is preferably 3 μm to 20 μm.

The metallic lithium layer in the form (1) is a layer of simple substance of lithium. The thickness of the metallic lithium layer is preferably 0.1 μm to 100 μm. As the metallic lithium layer, a commercial metallic lithium foil can be used. The metallic lithium layer may be formed on the current collector by a vapor deposition method.

### —Form (2)—

In the negative electrode of the form (2), it is not necessary to provide the negative electrode active material layer on the current collector in advance. In the lithium secondary battery employing the form (2), lithium ions dedoped from the lithium-containing active material of the positive electrode are precipitated as metallic lithium on the negative electrode current collector during charging.

The current collector in the form (2) is preferably a metal foil. Examples of the metal foil include a copper foil, a silver foil, a stainless steel foil, a palladium foil, and the like. The current collector in the form (2) is preferably a copper foil. The thickness of the current collector in the form (2) is preferably 3 μm to 20 μm.

The negative electrode of the form (2) is thinner than the negative electrode of the form (1) and is advantageous, from the viewpoint of increasing the energy density of the battery.

### [Electrolyte Solution]

The electrolyte solution contains a nonaqueous solvent and a lithium salt and has a lithium salt concentration of 3.0 mol/L or more. When a plurality of types of lithium salts are contained in the electrolyte solution, the total concentration of the plurality of types of lithium salts contained in the electrolyte solution is 3.0 mol/L or more.

It has been reported that a high salt concentration electrolyte solution having a high lithium salt concentration has a characteristic solution structure (Y. Yamada, et al., J. Am. Chem. Soc., 136, 5039-5046, 2014). This solution structure is characterized in that all the solvent molecules are coordinated to lithium ions (Lit) and there are no uncoordinated solvent molecules and that four coordination which is the stable solvation state of Lit is still not achieved and the counter anion of the lithium salt is coordinated to Lit.

The high salt concentration electrolyte solution having the above solution structure exhibits characteristics such as electrochemically high stability, decrease in volatility and combustibility, expansion of a potential window, and suppression of elution of the transition metal in the positive electrode active material.

The lithium salt concentration of the electrolyte solution is 3.0 mol/L or more, preferably 5.0 mol/L or more, and more preferably 5.3 mol/L or more, from the viewpoint of achieving the characteristics of the high salt concentration electrolyte solution.

The lithium salt concentration of the electrolyte solution is preferably 10.0 mol/L or less, more preferably 7.0 mol/L or less, and still more preferably 6.0 mol/L or less, from the viewpoint of suppressing the viscosity of the electrolyte solution.

The lithium salt concentration of the electrolyte solution is preferably 3.0 mol/L to 7.0 mol/L, and more preferably 5.0 mol/L to 6.0 mol/L, from the viewpoint of accomplishing both achievement of the characteristics of the high salt concentration electrolyte solution and suppression of the viscosity.

Examples of the nonaqueous solvent include any known nonaqueous solvents used in lithium secondary batteries. Specific examples thereof include: cyclic carbonates such as ethylene carbonate, propylene carbonate, fluoroethylene carbonate, difluoroethylene carbonate, and vinylene carbonate; chain carbonates such as dimethyl carbonate, diethyl carbonate, ethyl methyl carbonate, and fluorine-substituted compounds thereof; cyclic esters such as γ-butyrolactone and γ-valerolactone; chain esters such as methyl acetate; such ethers as 1,2-dimethoxyethane, ethylmethyl ether, dipropyl ether, and tetrahydrofuran; nitriles such as acetonitrile and methoxypropionitrile; amines such as triethylamine; alcohols such as methanol; ketones such as acetone; fluorine-containing alkanes; dimethyl sulfoxide; sulfolane; and the like. One thereof may be used alone, or a mixture thereof may be used.

As the nonaqueous solvent, chain carbonates such as dimethyl carbonate, diethyl carbonate, ethyl methyl carbonate, and a fluorine-substituted compound thereof, which are solvents having a relatively low viscosity, are preferable, and dimethyl carbonate is more preferable. An electrolyte solution using a solvent having a relatively low viscosity has a relatively low viscosity even when a lithium salt is contained at a high concentration and has high permeability into the separator.

Examples of the lithium salt include any known lithium salts used in lithium secondary batteries. Specific examples thereof include: sulfonamide lithium salts and sulfonimide lithium salts such as Li(FSO₂)₂N (also called “LiFSA” or “LiFSI”), Li(CF₃SO₂)₂N (also called “LiTFSA” or “LiTFSI”), Li(C₂F₅SO₂)₂N (also called “LiBETA” or “LiBETI”), Li(CF₃SO₂)(C₂F₅SO₂)N, Li(CF₃SO₂)(C₃F₇SO₂)N, and Li(CF₃SO₂)(C₄F₉SO₂) N; sulfone methide lithium salts such as Li(CF₃SO₂)₃C; lithium sulfonates such as LiCF₃SO₃ and LiC₄F₉SO₃; LiPF₆, LiBF₄, and LiClO₄; and the like. One thereof may be used alone, or a mixture thereof may be used.

The lithium salt is preferably at least one selected from the group consisting of a sulfonamide lithium salt and a sulfonimide lithium salt, from the viewpoint of excellent cycle characteristics of the secondary battery by containing a bulky anion and being easily dissociated and electrochemically stable. Specifically, Li(FSO₂)₂N (also called “LiFSA” or “LiFSI”), Li(CF₃SO₂)₂N (also called “LiTFSA” or “LiTFSI”), Li(C₂F₅SO₂)₂N (also called “LiBETA” or “LiBETI”), Li(CF₃SO₂)(C₂F₅SO₂)N, Li(CF₃SO₂)(C₃F₇SO₂)N, Li(CF₃SO₂)(C₄F₉SO₂)N, and the like are preferable.

The electrolyte solution is preferably an electrolyte solution in which the nonaqueous solvent is dimethyl carbonate and which contains at least one lithium salt selected from the group consisting of a sulfonamide lithium salt and a sulfonimide lithium salt and has a lithium salt concentration of 3.0 mol/L to 7.0 mol/L. Here, the lithium salt concentration is more preferably 5.0 mol/L to 6.0 mol/L.

The electrolyte solution may contain an additive. Examples of the additive include vinylene carbonate, propane sultone, tert-butylbenzene, fluoroethylene carbonate, lithium bis(oxalate)borate, succinonitrile, adiponitrile, triisopropoxy boroxine, sulfolane, hydrofluoroether, vinyl acetate, and the like. One thereof may be used alone, or a mixture thereof may be used.

### [Separator (A)]

The separator (A) has a polyolefin microporous film and the porous layer (A) provided on one side or both sides of the polyolefin microporous film. The porous layer (A) is a porous layer containing a wholly aromatic polyamide. The porous layer (A) is preferably the outermost layer of the separator on one side or both sides of the polyolefin microporous film.

Embodiments of the separator (A) include the following forms (a) to (c).

Form (a): A separator having the porous layer (A) on both sides of the polyolefin microporous film. In the separator, the components and/or the compositions of the porous layer (A) on one side and the porous layer (A) on the other side may be the same or different.

Form (b): A separator having the porous layer (A) on one side of the polyolefin microporous film and another porous layer (namely, a porous layer containing no wholly aromatic polyamide) on the other side of the polyolefin microporous film. An example of the other porous layer is an adhesive layer intended for adhesion between the positive electrode and the separator (A).

Form (c): A separator which has the porous layer (A) on one side of the polyolefin microporous film and does not have any layer on the other side of the polyolefin microporous film (that is, the surface of the polyolefin microporous film is exposed).

The separator (A) is preferably in the form (a) from the viewpoint of further excellent permeability of the high salt concentration electrolyte solution.

The separator (A) is preferably in the form (c) from the viewpoint of obtaining a secondary battery having a higher energy density while suppressing the thickness of the entire separator.

Hereinafter, the details of the polyolefin microporous film and the porous layer (A) of the separator (A) will be explained.

### —Polyolefin Microporous Film—

In the present disclosure, the polyolefin microporous film means a microporous film containing polyolefin. In the present disclosure, the microporous film means a film having a large number of micropores therein, having a structure in which the micropores are connected to each other and allowing gas or liquid to pass from one side to the other side.

Examples of the polyolefin microporous film include any known polyolefin microporous films used in separators for a battery. The polyolefin microporous film preferably contains polyethylene, from the viewpoint of exhibiting shutdown function. The polyolefin microporous film preferably contains polypropylene, from the viewpoint of imparting heat resistance to the extent that the film is not easily broken when exposed to a high temperature.

The polyolefin microporous film preferably contains polyethylene and polypropylene, from the viewpoint of imparting shutdown function and heat resistance to the extent that the film is not easily broken when exposed to a high temperature. Examples of the polyolefin microporous film containing polyethylene and polypropylene include a microporous film in which polyethylene and polypropylene are mixed in one layer. The microporous film preferably contains 95% by mass or more of polyethylene and 5% by mass or less of polypropylene as a mixture, from the viewpoint of achieving both shutdown function and heat resistance. In addition, from the viewpoint of achieving both shutdown function and heat resistance, a polyolefin microporous film having a lamination structure with two or more layers in which at least one layer contains polyethylene and at least one layer contains polypropylene is also preferable.

An example of the embodiment of the polyolefin microporous film is a polyethylene microporous film containing polyethylene as the main component. The mass of polyethylene in the entire mass of the polyethylene microporous film is preferably 95% by mass or more.

The polyolefin contained in the polyolefin microporous film is preferably a polyolefin having a weight-average molecular weight (Mw) of 100,000 to 5,000,000. When the Mw of the polyolefin is 100,000 or more, sufficient mechanical properties may be provided to the microporous film. When the Mw of the polyolefin is 5,000,000 or less, the shutdown characteristic of the microporous film is favorable, and formation of the microporous film is easy.

The Mw of the polyolefin is a molecular weight in terms of polystyrene measured by gel permeation chromatography (GPC). The polyolefin extracted from the microporous film or the polyolefin used for forming the microporous film is measured as a sample.

Examples of the method for producing the polyolefin microporous film include: a method of extruding a molten polyolefin from a T-die to form a sheet, crystallizing and then stretching the sheet, and then subjecting the sheet to heat treatment, thereby obtaining a microporous film; a method of extruding a polyolefin melted with a plasticizer such as liquid paraffin from a T-die, cooling it to form a sheet, stretching the sheet, then extracting the plasticizer, and performing heat treatment, thereby obtaining a microporous film; and the like.

The surface of the polyolefin microporous film may be subjected to various surface treatments within the range of not impairing the nature of the polyolefin microporous film, for the purpose of improving the wettability with the coating liquid for forming the porous layer (A). Examples of the surface treatment include corona treatment, plasma treatment, flame treatment, UV irradiation treatment, and the like.

### —Characteristics of Polyolefin Microporous Film—

The thickness of the polyolefin microporous film is preferably 3 μm or more, more preferably 5 μm or more, and still more preferably 6 μm or more, from the viewpoint of the production yield of the separator and the production yield of the battery.

The thickness of the polyolefin microporous film is preferably 25 μm or less, more preferably 20 μm or less, and still more preferably 15 μm or less, from the viewpoint of increasing the energy density of the battery.

The thickness (μm) of the polyolefin microporous film is a value obtained by measuring 20 points in a 10-cm square with a contact type thickness meter and taking an average thereof.

The Gurley value (JIS P8117: 2009) of the polyolefin microporous film is preferably 20 seconds/100 mL or more, more preferably 30 seconds/100 mL or more, and still more preferably 50 seconds/100 mL or more, from the viewpoint of suppressing a short circuit of the battery.

The Gurley value (JIS P8117: 2009) of the polyolefin microporous film is preferably 200 seconds/100 mL or less, more preferably 180 seconds/100 mL or less, and still more preferably 160 seconds/100 mL or less, from the viewpoint of ion permeability.

The Gurley value of the polyolefin microporous film is determined by measuring using a Gurley densometer according to JIS P8117: 2009.

The porosity of the polyolefin microporous film is preferably 20% to 60%, and more preferably 30% to 50%, from the viewpoint of obtaining appropriate film resistance and shutdown function. The porosity ε (%) of the polyolefin microporous film is determined by the following equation.

$$ε = \{ 1 - Ws / ( ds \cdot t ) \} \times 100$$

Here, Ws is the basis weight (g/m²) of the polyolefin microporous film, ds is the true density (g/cm³) of the polyolefin microporous film, and t is the thickness (μm) of the polyolefin microporous film. The basis weight refers to the mass per unit area.

The average pore size of the polyolefin microporous film is preferably 15 nm to 100 nm from the viewpoint of achieving both ion permeability and suppression of a short circuit of the battery. The average pore size of the polyolefin microporous film is measured using a Perm Porometer (CFP-1500-A, PMI) according to ASTM E1294-89.

A preferable form of the polyolefin microporous film is a form in which the wall surfaces of the pores of the polyolefin microporous film are partially or entirely covered with a wholly aromatic polyamide. The high salt concentration electrolyte solution easily permeates the polyolefin microporous film of this form.

A preferable form of the polyolefin microporous film is a form in which a fibrous wholly aromatic polyamide is contained in the pores of the polyolefin microporous film. The high salt concentration electrolyte solution easily permeates the polyolefin microporous film of this form.

From the viewpoint of permeability of the high salt concentration electrolyte solution into the polyolefin microporous film, a fibrous wholly aromatic polyamide is preferably contained in the pores at least in a region close to the surface of the polyolefin microporous film, and the fibrous wholly aromatic polyamide is more preferably contained in the pores of the entire polyolefin microporous film.

Since the wholly aromatic polyamide is in the form of fine fibers, the micropores of the polyolefin microporous film are not blocked, and therefore gas or liquid can pass from one side to the other side of the polyolefin microporous film.

The details and preferable forms of the wholly aromatic polyamide constituting the fibrous wholly aromatic polyamide are the same as those of the wholly aromatic polyamide contained in the porous layer (A) (described later).

### —Porous Layer (A)—

In the present disclosure, the porous layer has a large number of micropores therein, has a structure in which the micropores are connected to each other and is a layer through which gas or liquid can pass from one side to the other side.

The porous layer (A) contains a wholly aromatic polyamide. The wholly aromatic polyamide means a polyamide having a principal chain composed only of a benzene ring and an amide bond. However, the wholly aromatic polyamide may be copolymerized with a small amount of an aliphatic monomer. The wholly aromatic polyamide is also called aramid.

The wholly aromatic polyamide may be a meta-type wholly aromatic polyamide, a para-type wholly aromatic polyamide, or a mixture of a meta-type wholly aromatic polyamide and a para-type wholly aromatic polyamide.

The wholly aromatic polyamide is preferably a polymer having high flexibility from the viewpoint of easily entering the pores of the polyolefin microporous film during the formation of the porous layer (A). From this viewpoint, the wholly aromatic polyamide is preferably a meta-type wholly aromatic polyamide rather than a para-type wholly aromatic polyamide. When the wholly aromatic polyamide (for example, a meta-type wholly aromatic polyamide) is attached to the wall surfaces of the pores of the polyolefin microporous film or when the fibrous wholly aromatic polyamide (for example, a fibrous meta-type wholly aromatic polyamide) is contained in the pores, the high salt concentration electrolyte solution easily permeates the polyolefin microporous film.

The wholly aromatic polyamide is preferably a meta-type wholly aromatic polyamide and particularly preferably polymetaphenylene isophthalamide from the viewpoint of easily entering the pores of the polyolefin microporous film during the formation of the porous layer (A).

The content of the wholly aromatic polyamide contained in the porous layer (A) is preferably 85% by mass to 100% by mass, more preferably 90% by mass to 100% by mass, still more preferably 95% by mass to 100% by mass, and particularly preferably 100% by mass with respect to the total resin amount contained in the porous layer (A).

When the porous layer (A) is provided on both sides of the polyolefin microporous film, the type and/or the content of the wholly aromatic polyamide contained in one porous layer (A) and the type and/or the content of the wholly aromatic polyamide contained in the other porous layer (A) may be the same or different.

The porous layer (A) may contain a resin other than the wholly aromatic polyamide. Examples of the other resin include polyamideimide, poly-N-vinylacetamide, polyacrylamide, copolymerized polyether polyamide, polyimide, polyetherimide, a polyvinylidene fluoride type resin, an acrylic type resin, fluorine-based rubber, a styrene-butadiene copolymer, a homopolymer or a copolymer of a vinyl nitrile compound (acrylonitrile, methacrylonitrile, or the like), carboxymethyl cellulose, hydroxyalkyl cellulose, polyvinyl alcohol, polyvinyl butyral, polyvinyl pyrrolidone, polyether (polyethylene oxide, polypropylene oxide, or the like), polysulfone, polyketone, polyether ketone, polyether sulfone, and a mixture thereof.

The content of the other resin contained in the porous layer (A) is preferably 0% by mass to 15% by mass, more preferably 0% by mass to 10% by mass, still more preferably 0% by mass to 5% by mass, and particularly preferably 0% by mass with respect to the total resin amount contained in the porous layer (A). It is ideal that the porous layer (A) does not contain any other resin than the wholly aromatic polyamide.

The porous layer (A) preferably contains inorganic particles from the viewpoint of the heat resistance of the layer and of making the layer porous.

Examples of the inorganic particles include metal sulfate particles, metal hydroxide particles, metal oxide particles, metal carbonate particles, metal nitride particles, metal fluoride particles, clay mineral particles, and the like. One kind of the inorganic particles may be used alone, or a combination of two or more kinds thereof may be used.

Examples of the metal sulfate constituting the metal sulfate particles include barium sulfate, strontium sulfate, calcium sulfate, calcium sulfate dihydrate, alum, jarosite, and the like.

Examples of the metal hydroxide constituting the metal hydroxide particles include magnesium hydroxide, aluminum hydroxide, calcium hydroxide, chromium hydroxide, zirconium hydroxide, cerium hydroxide, nickel hydroxide, and the like.

Examples of the metal oxide constituting the metal oxide particles include barium titanate (BaTio₃), magnesium oxide, alumina (Al₂O₃), boehmite (alumina monohydrate), titania (TiO₂), silica (SiO₂), zirconia (ZrO₂), zinc oxide, and the like.

Examples of the metal carbonate constituting the metal carbonate particles include calcium carbonate, magnesium carbonate, and the like.

Examples of the metal nitride constituting the metal nitride particles include magnesium nitride, aluminum nitride, calcium nitride, titanium nitride, and the like.

Examples of the metal fluoride constituting the metal fluoride particles include magnesium fluoride, calcium fluoride, and the like.

Examples of the clay mineral constituting the clay mineral particles include calcium silicate, calcium phosphate, apatite, talc, and the like.

The inorganic particles may be inorganic particles surface-modified with a silane coupling agent or the like.

As the inorganic particles, metal sulfate particles are preferable, and barium sulfate particles are more preferable, from the viewpoint that the particles do not easily decompose the electrolyte solution or the electrolyte and thus do not easily cause gas generation in the battery.

When metal sulfate particles are used as the inorganic particles, the amount of the metal sulfate particles in the entire inorganic particles contained in the porous layer (A) is preferably 80% by mass or more, more preferably 85% by mass or more, still more preferably 90% by mass or more, further more preferably 95% by mass or more, and most preferably 100% by mass, from the viewpoint of suppressing gas generation in the battery.

When barium sulfate particles are used as the inorganic particles, the amount of the barium sulfate particles in the entire inorganic particles contained in the porous layer (A) is preferably 80% by mass or more, more preferably 85% by mass or more, still more preferably 90% by mass or more, further more preferably 95% by mass or more, and most preferably 100% by mass, from the viewpoint of suppressing gas generation in the battery.

From the viewpoint of high electrochemical stability, as the inorganic particles, magnesium compound particles such as magnesium oxide particles, magnesium hydroxide particles, magnesium carbonate particles, magnesium nitride particles, and magnesium fluoride particles are preferable, and at least one selected from the group consisting of magnesium oxide particles and magnesium hydroxide particles is more preferable.

When magnesium compound particles are used as the inorganic particles, the amount of the magnesium compound particles in the entire inorganic particles contained in the porous layer (A) is preferably 80% by mass or more, more preferably 85% by mass or more, still more preferably 90% by mass or more, further more preferably 95% by mass or more, and most preferably 100% by mass, from the viewpoint of high electrochemical stability.

When the porous layer (A) is provided on both sides of the polyolefin microporous film, the type and/or the content of the inorganic particles contained in one porous layer (A) and the type and/or the content of the inorganic particles contained in the other porous layer (A) may be the same or different.

The particle shape of the inorganic particles is not limited and may be any of a spherical shape, a plate shape, a needle shape, and an indefinite shape. From the viewpoint of suppressing a short circuit of the battery and the viewpoint of forming a dense porous layer having high uniformity, the inorganic particles are preferably spherical or plate-shaped particles and non-aggregated primary particles.

The average primary particle diameter of the inorganic particles contained in the porous layer (A) is preferably 0.3 μm or less, more preferably 0.01 μm or more and 0.2 μm or less, and still more preferably 0.03 μm or more and 0.15 μm or less from the viewpoint of making the layer porous and the viewpoint of forming a dense porous layer having high uniformity.

When metal sulfate particles are used as the inorganic particles, the average primary particle diameter of the metal sulfate particles contained in the porous layer (A) is preferably 0.3 μm or less, more preferably 0.01 μm or more and 0.2 μm or less, and still more preferably 0.03 μm or more and 0.15 μm or less from the viewpoint of making the layer porous and the viewpoint of forming a dense porous layer having high uniformity.

When barium sulfate particles are used as the inorganic particles, the average primary particle diameter of the barium sulfate particles contained in the porous layer (A) is preferably 0.3 μm or less, more preferably 0.01 μm or more and 0.2 μm or less, and still more preferably 0.03 μm or more and 0.15 μm or less from the viewpoint of making the layer porous and the viewpoint of forming a dense porous layer having high uniformity.

When magnesium compound particles are used as the inorganic particles, the average primary particle diameter of the magnesium compound particles contained in the porous layer (A) is preferably 0.3 μm or less, more preferably 0.01 μm or more and 0.2 μm or less, and still more preferably 0.03 μm or more and 0.15 μm or less from the viewpoint of making the layer porous and the viewpoint of forming a dense porous layer having high uniformity.

The average primary particle diameter of the inorganic particles contained in the porous layer is determined by measuring the major diameters of 100 inorganic particles randomly selected by observation with a scanning electron microscope (SEM) and averaging the major diameters of the 100 inorganic particles. The sample subjected to the SEM observation is the inorganic particles which are a material for forming the porous layer or the inorganic particles which are taken out from the porous layer of the separator. The method for taking out the inorganic particles from the porous layer of the separator is not restricted. Examples of the method include: a method in which the porous layer peeled off from the separator is immersed in an organic solvent in which the resin is dissolved to dissolve the resin in the organic solvent and take out the inorganic particles; a method in which the porous layer peeled off from the separator is heated to about 800° C. to eliminate the resin and take out the inorganic particles.

When the porous layer (A) is provided on both sides of the polyolefin microporous film, the average primary particle diameter of the inorganic particles contained in one porous layer (A) and the average primary particle diameter of the inorganic particles contained in the other porous layer (A) may be the same or different.

The volume ratio of the inorganic particles to the solid content volume of the porous layer (A) is preferably 10% by volume or more and 90% by volume or less, more preferably 20% by volume or more and 80% by volume or less, and still more preferably 30% by volume or more and 75% by volume or less. In the present disclosure, the solid content volume of the porous layer means the volume of the porous layer excluding the pores.

When metal sulfate particles are used as the inorganic particles, the volume ratio of the metal sulfate particles to the solid content volume of the porous layer (A) is preferably 10% by volume or more and 90% by volume or less, more preferably 20% by volume or more and 80% by volume or less, and still more preferably 30% by volume or more and 75% by volume or less.

When barium sulfate particles are used as the inorganic particles, the volume ratio of the barium sulfate particles to the solid content volume of the porous layer (A) is preferably 10% by volume or more and 90% by volume or less, more preferably 20% by volume or more and 80% by volume or less, and still more preferably 30% by volume or more and 75% by volume or less.

When magnesium compound particles are used as the inorganic particles, the volume ratio of the magnesium compound particles to the solid content volume of the porous layer (A) is preferably 10% by volume or more and 90% by volume or less, more preferably 20% by volume or more and 80% by volume or less, and still more preferably 30% by volume or more and 75% by volume or less.

The volume ratio V (% by volume) of the inorganic particles to the solid content volume of the porous layer is determined by the following equation.

V={(Xa/Da)/(Xa/Da+Xb/Db+Xc/Dc+ . . . +Xn/Dn)}×100

Here, of the constituent materials of the porous layer, the inorganic particles are a, the other constituent materials are b, c, . . . , and n, the mass of each constituent material contained in the porous layer having a predetermined area is Xa, Xb, Xc, . . . , or Xn (g), and the true density of each constituent material is Da, Db, Dc, . . . , or Dn (g/cm³).

Xa or the like substituted into the above equation is the mass (g) of the constituent material used for forming the porous layer having a predetermined area or the mass (g) of the constituent material taken out from the porous layer having a predetermined area.

Da or the like substituted into the above equation is the true density (g/cm³) of the constituent material used for forming the porous layer or the true density (g/cm³) of the constituent material taken out from the porous layer.

When the porous layer (A) is provided on both sides of the polyolefin microporous film, the volume ratio of the inorganic particles to the solid content volume of one porous layer (A) and the volume ratio of the inorganic particles to the solid content volume of the other porous layer (A) may be the same or different.

The porous layer (A) may contain an organic filler. Examples of the organic filler include: particles of a crosslinked polymer such as crosslinked poly (meth)acrylic acid, crosslinked poly (meth)acrylate, crosslinked polysilicone, crosslinked polystyrene, crosslinked polydivinylbenzene, a styrene-divinylbenzene copolymer crosslinked product, polyimide, a melamine resin, a phenol resin, and a benzoguanamine-formaldehyde condensate; particles of a heat-resistant polymer such as polysulfone, polyacrylonitrile, aramid, polyacetal, and thermoplastic polyimide; and the like. The expression “(meth)acryl” means that the term may be either “acryl” or “methacryl”.

The resin constituting the organic filler may be a mixture, a modified product, a derivative, a copolymer (a random copolymer, an alternating copolymer, a block copolymer, or a graft copolymer), or a crosslinked product of the above exemplary materials. One kind of the organic fillers may be used alone, or a combination of two or more kinds thereof may be used.

The porous layer (A) may contain an additive, for example, a dispersant such as a surfactant, a wetting agent, an antifoaming agent, a pH adjuster, or the like. The dispersant is added to a coating liquid for forming the porous layer (A) for the purpose of improving the dispersibility, the coatability, or the storage stability. The wetting agent, the antifoaming agent, or the pH adjuster is added to a coating liquid for forming the porous layer (A), for example, for the purpose of improving the compatibility with the polyolefin microporous film, for the purpose of suppressing mixing of air into the coating liquid, or for the purpose of adjusting the pH.

### —Characteristics of Porous Layer (A)—

The thickness of the porous layer (A) is preferably 0.1 μm or more per side, more preferably 0.5 μm or more per side, and still more preferably 1.0 μm or more per side, from the viewpoint of the handleability during the production of the battery.

The thickness of the porous layer (A) is preferably 10.0 μm or less per side, more preferably 8.0 μm or less per side, and still more preferably 6.0 μm or less per side, from the viewpoint of improving the ion permeability and the energy density of the battery.

When the porous layer (A) is provided on both sides of the polyolefin microporous film, the thickness of the porous layer (A) is preferably 1.0 μm or more, more preferably 2.0 μm or more, still more preferably 3.0 μm or more and is preferably 20.0 μm or less, more preferably 16.0 μm or less, and still more preferably 12.0 μm or less, in terms of the total thickness of both sides.

The thickness of the porous layer (A) (the total thickness of both sides of the polyolefin microporous film, μm) is the value obtained by subtracting the thickness (μm) of the polyolefin microporous film from the thickness (μm) of the separator (A).

When the porous layer (A) is provided on both sides of the polyolefin microporous film, the difference (μm) between the thickness of one porous layer (A) and the thickness of the other porous layer (A) is preferably as small as possible and is preferably 20% or less of the total thickness (μm) of both sides.

The mass per unit area of the porous layer (A) is preferably 1.0 g/m² or more, more preferably 2.0 g/m² or more, and still more preferably 3.0 g/m² or more, in terms of the total mass of both sides, from the viewpoint of the handleability during the production of the battery, both in a case where the porous layer (A) is provided on one side of the polyolefin microporous film and a case where the porous layer (A) is provided on both sides thereof.

The mass per unit area of the porous layer (A) is preferably 30.0 g/m² or less, more preferably 20.0 g/m² or less, and still more preferably 10.0 g/m² or less, in terms of the total mass of both sides, from the viewpoint of the ion permeability and the energy density of the battery, both in a case where the porous layer (A) is provided on one side of the polyolefin microporous film and a case where the porous layer (A) is provided on both sides thereof.

When the porous layer (A) is provided on both sides of the polyolefin microporous film, the difference (g/m²) between the mass per unit area of one porous layer (A) and the mass per unit area of the other porous layer (A) is preferably as small as possible and is preferably 20% or less of the total amount (g/m²) of both sides from the viewpoint of suppressing curling of the separator or from the viewpoint of improving the cycle characteristics of the battery.

The porosity of the porous layer (A) is preferably 30% or more, more preferably 35% or more, and still more preferably 40% or more, from the viewpoint of ion permeability.

The porosity of the porous layer (A) is preferably 80% or less, more preferably 70% or less, and still more preferably 60% or less, from the viewpoint of the mechanical strength of the porous layer (A).

The porosity ε (%) of the porous layer is determined by the following equation.

$$ε = ( 1 - \frac{{\sum }_{i = 1}^{n} \frac{Wi}{di}}{t} ) \times 100 \qquad [ Math . 1 ]$$

Here, regarding the constituent material 1, the constituent material 2, the constituent material 3, . . . , and the constituent material n of the porous layer, the mass per unit area of each constituent material is W₁, W₂, W₃, . . . , or Wₙ (g/cm²), the true density of each constituent material is d₁, d₂, d₃, . . . , and dₙ (g/cm³), and the thickness of the porous layer is t (cm).

### [Characteristics of Separator (A)]

The thickness of the separator (A) is preferably 5 μm or more, more preferably 10 μm or more, and still more preferably 15 μm or more, from the viewpoint of mechanical strength.

The thickness of the separator (A) is preferably 30 μm or less, more preferably 25 μm or less, and still more preferably 20 μm or less, from the viewpoint of increasing the energy density of the battery.

The thickness (μm) of the separator (A) is a value obtained by measuring 20 points in a 10-cm square with a contact type thickness meter and taking an average thereof.

The Gurley value (JIS P8117: 2009) of the separator (A) is preferably 40 seconds/100 mL or more, more preferably 50 seconds/100 mL or more, and still more preferably 60 seconds/100 mL or more, from the viewpoint of suppressing a short circuit of the battery.

The Gurley value (JIS P8117: 2009) of the separator (A) is preferably 200 seconds/100 mL or less, more preferably 180 seconds/100 mL or less, and still more preferably 160 seconds/100 ml or less, from the viewpoint of ion permeability.

The Gurley value of the separator is determined by measuring using a Gurley densometer according to JIS P8117: 2009.

### [Method for Producing Separator (A)]

The separator (A) can be produced, for example, by forming the porous layer (A) on the polyolefin microporous film by a wet coating method or a dry coating method. In the present disclosure, the wet coating method is a method of solidifying a coating layer in a coagulation liquid, and the dry coating method is a method of drying a coating layer to solidify the coating layer. Hereinafter, embodiment examples of the wet coating method will be explained.

The wet coating method is a method of applying a coating liquid for forming a porous layer onto a polyolefin microporous film, immersing the resulting product in a coagulation liquid to solidify the coating layer, pulling the resulting product out of the coagulation liquid, washing with water, and drying.

The coating liquid for forming the porous layer (A) is produced by dissolving the wholly aromatic polyamide in a solvent. In the coating liquid, a component other than the wholly aromatic polyamide is dissolved or dispersed as necessary.

The solvent used for preparing the coating liquid includes a solvent in which the wholly aromatic polyamide is dissolved (hereinafter, also referred to as “good solvent”). An example of the good solvent is a polar amide solvent such as N-methylpyrrolidone, dimethylacetamide, and dimethylformamide.

The solvent used for preparing the coating liquid may contain a phase separation agent that t induces phase separation from the viewpoint of forming a porous layer having a favorable porous structure. Therefore, the solvent used for preparing the coating liquid may be a mixed solvent of the good solvent and a phase separation agent. The phase separation agent is preferably mixed with the good solvent in such an amount that a viscosity suitable for coating can be ensured. Examples of the phase separation agent include water, methanol, ethanol, propyl alcohol, butyl alcohol, butanediol, ethylene glycol, propylene glycol, tripropylene glycol, and the like.

When the solvent used for preparing the coating liquid is a mixed solvent of the good solvent and the phase separation agent, from the viewpoint of forming a favorable porous structure, a mixed solvent containing 60% by mass or more of the good solvent and 5% by mass to 40% by mass of the phase separation agent is preferable.

The resin concentration of the coating liquid is preferably 1% by mass to 20% by mass from the viewpoint of forming a favorable porous structure. The inorganic particle concentration of the coating liquid is preferably 0.5% by mass to 50% by mass from the viewpoint of forming a favorable porous structure.

The coating liquid may contain a dispersant such as a surfactant, a wetting agent, an antifoaming agent, a pH adjuster, or the like. These additives may remain in the porous layer as long as they are electrochemically stable and do not inhibit the reaction in the battery within the range of use of the secondary battery.

Examples of the means of applying the coating liquid to the polyolefin microporous film include a Meyer bar, a die coater, a reverse roll coater, a roll coater, a gravure coater, and the like. When the porous layer is formed on both sides of the polyolefin microporous film, it is preferable to simultaneously apply the coating liquid to both sides of the polyolefin microporous film from the viewpoint of productivity.

The coating layer is solidified by immersing the polyolefin microporous film having the coating layer formed thereon in a coagulation liquid and solidifying the resin while inducing phase separation in the coating layer. As a result, a laminated body composed of the polyolefin microporous film and the porous layer is obtained.

The coagulation liquid generally contains the good solvent and the phase separation agent used for preparing the coating liquid and water. The mixing ratio between the good solvent and the phase separation agent is preferably matched with the mixing ratio of the mixed solvent used for preparing the coating liquid in terms of production. The content of water in the coagulation liquid is preferably 40% by mass to 90% by mass from the viewpoint of formation of a porous structure and productivity. The temperature of the coagulation liquid is, for example, 20° C. to 50° C.

After the coating layer is solidified in the coagulation liquid, the laminated body is pulled out of the coagulation liquid and washed with water. By washing the laminated body with water, the coagulation liquid is removed from the laminated body. Furthermore, by drying the laminated body, water is removed from the laminated body. Washing with water is performed, for example, by transporting the laminated body in a water bath. Drying is performed, for example, by transporting the laminated body in a high-temperature environment, blowing air to the laminated body, or bringing the laminated body into contact with a heat roll. The drying temperature is preferably 40° C. to 80° C.

The separator (A) can also be produced by a dry coating method. The dry coating method is a method of applying a coating liquid to a polyolefin microporous film, drying the coating layer to remove the solvent by evaporation, and thereby forming a porous layer on the polyolefin microporous film.

The separator (A) can also be produced by a method of producing the porous layer (A) as an independent sheet, stacking the porous layer (A) on the polyolefin microporous film, and forming a composite by thermal press bonding or an adhesive. An example of the method of producing the porous layer (A) as an independent sheet is a method of forming the porous layer on a release sheet by applying the wet coating method or the dry coating method described above.

### [Shape and Production Method of Lithium Secondary Battery]

The shape of the lithium secondary battery may be any of a square shape, a cylindrical shape, a coin shape, a pouch shape, and the like.

Examples of the exterior material of the lithium secondary battery include a metal can, an aluminum laminated film pack, and the like.

The lithium secondary battery is produced, for example, through a process of producing a laminated body in which a separator is disposed between a positive electrode and a negative electrode, a process of housing the laminated body and an electrolyte solution in an exterior material and causing the electrolyte solution to permeate into the laminated body, and a process of bringing the inside of the exterior material into a vacuum state and sealing the exterior material.

In the production of the laminated body in which the separator is disposed between the positive electrode and the negative electrode, the method of disposing the separator between the positive electrode and the negative electrode may be a method of stacking at least one layer each of the positive electrode, the separator, and the negative electrode in this order (so-called stack method) or may be a method of stacking the positive electrode, the separator, the negative electrode, and the separator in this order and winding them in the length direction.

In an example of an embodiment, the lithium secondary battery has a laminated body in which the positive electrode, the separator, and the negative electrode are wound and the electrolyte solution in a cylindrical metal can.

### EXAMPLES

Hereinafter, the lithium secondary battery of the present disclosure will be explained further specifically referring to Examples. The materials, the used amounts, the ratios, the treatment procedures, and the like illustrated in the following Examples can be changed, if appropriate without departing from the gist of the present disclosure. Therefore, the range of the lithium secondary battery of the present disclosure should not be limitatively interpreted by the following specific examples.

### <Measurement Methods and Evaluation Methods>

The measurement methods and the evaluation methods applied in Examples and Comparative Examples are as follows.

### [Thicknesses of Polyolefin Microporous Film and Separator]

The thicknesses (μm) of the polyolefin microporous film and the separator were determined by measuring 20 points in a 10-cm square with a contact type thickness meter (Mitutoyo Corporation, LITEMATIC VL-50S) and taking an average thereof. A spherical probe (Mitutoyo Corporation) with a sphere radius of 10 mm was used for the measuring terminal and was adjusted in such a manner that a load of 0.19 N was applied during the measurement.

### [Thickness of Porous Layer]

The thickness of the porous layer (the total thickness of both sides, μm) was determined by subtracting the thickness (μm) of the polyolefin microporous film from the thickness (μm) of the separator.

### [Porosity of Polyolefin Microporous Film]

The porosity ε (%) of the polyolefin microporous film was determined by the following equation.

$$ε = \{ 1 - Ws / ( ds \cdot t ) \} \times 100$$

Here, Ws is the basis weight (g/m²) of the polyolefin microporous film, ds is the true density (g/cm³) of the polyolefin microporous film, and t is the thickness (μm) of the polyolefin microporous film.

### [Gurley Value of Polyolefin Microporous Film]

The Gurley value (second/100 mL) of the polyolefin microporous film was measured using a Gurley densometer (Toyo Seiki Seisaku-sho, Ltd., G-B2C) according to JIS P8117: 2009.

### [Average Primary Particle Diameter of Inorganic Particles]

The average primary particle diameter of the inorganic particles was determined by performing SEM observation using the inorganic particles used for forming the porous layer as a sample, measuring the major diameters of 100 randomly selected inorganic particles, and averaging the major diameters of the 100 inorganic particles.

### [Volume Ratio of Inorganic Particles]

The volume ratio V (% by volume) of the inorganic particles to the solid content volume of the porous layer was determined by the following equation.

$$V = \{ ( Xa / Da ) / ( Xa / Da + Xb / Db + Xc / Dc + … + Xn / Dn ) \} \times 100$$

Here, of the constituent materials of the porous layer, the inorganic particles are a, the other constituent materials are b, c, . . . , and n, the mass of each constituent material contained in the porous layer having a predetermined area is Xa, Xb, Xc, . . . , or Xn (g), and the true density of each constituent material is Da, Db, Dc, . . . , or Dn (g/cm³). Xa or the like substituted into the above equation is the mass (g) of the constituent material used for forming the porous layer having a predetermined area. Da or the like substituted into the above equation is the true density (g/cm³) of the constituent material used for forming the porous layer.

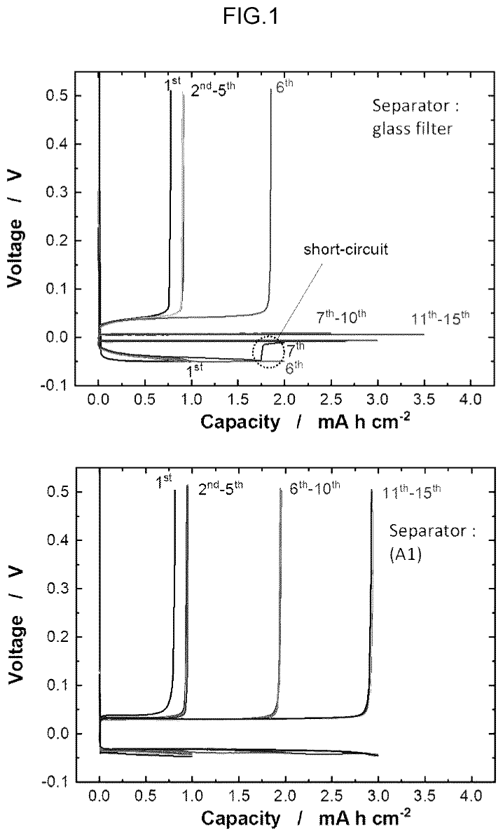

The abbreviations shown in Table 1 to Table 4 and FIG. 1 to FIG. 8 mean the following chemical substances.
DMC Dimethyl carbonate
EC Ethylene carbonate
FEC Fluoroethylene carbonate
LiFSA Li(FSO₂)₂N
PP Polypropylene

### <Production of Separator (A)>

Polymetaphenylene isophthalamide was dissolved in dimethylacetamide (DMAc) to a resin concentration of 4.0% by mass, and barium sulfate particles (average primary particle diameter of 0.05 μm) were further stirred and mixed to obtain a coating liquid (1).

An appropriate amount of the coating liquid (1) was placed on a Meyer bar, and the coating liquid (1) was applied to both sides of a polyethylene microporous film (thickness of 7 μm, porosity of 37%, and Gurley value of 123 seconds/100 mL). At this time, coating was performed in such a manner that the coating amounts on the front and back sides of the polyethylene microporous film were equal. The resulting film was immersed in a coagulation liquid (DMAC: water=50:50 [mass ratio], liquid temperature of 40° C.) to solidify the coating layers, subsequently washed in a water washing tank at a water temperature of 40° C. and dried. In this way, a separator in which porous layers were formed on both sides of a polyethylene microporous film was obtained. In the separator, the total average thickness of the porous layers on both sides was 4 μm, and the volume ratio of the barium sulfate particles to the solid content volume of the porous layers was 71% by volume. Hereinafter, this separator is referred to as “separator (A1)”.

### <Production of Lithium Secondary Battery>

### Reference Examples 1 to 4

Two-electrode cells of Reference Examples 1 to 4 were produced. The forms of these two-electrode cells are as shown in Table 1.

TABLE 1

| | | Reference | Reference | Reference | Reference |
|---|---|---|---|---|---|
| | | Example 1 | Example 2 | Example 3 | Example 4 |
| Positive Electrode for | | Copper foil/ | Copper foil/ | Copper foil/ | Copper foil/ |
| Experiment | | metallic lithium foil | metallic lithium foil | metallic lithium foil | metallic lithium foil |
| Negative Electrode | | Copper foil | Copper foil | Copper foil | Copper foil |
| Electrolyte | Nonaqueous | DMC | DMC | EC:DMC | EC:DMC |
| Solution | Solvent | | | Volume ratio of 3:7 | Volume ratio of 3:7 + |
| | | | | | 2% FEC |
| | Lithium Salt | LiFSA | LiFSA | LiPF₆ | LiPF₆ |
| | Lithium Salt | 5.7 mol/L | 5.7 mol/L | 1.0 mol/L | 1.0 mol/L |
| | Concentration | | | | |

| Separator | Glass fiber | Separator (A1) | Separator (A1) | Separator (A1) |
|---|---|---|---|---|
| | nonwoven fabric | | | |

The positive electrode is a form for experiment and is a laminated body of a commercial copper foil and a commercial metallic lithium foil.

The negative electrode is a commercial copper foil.

In the electrolyte solutions in Reference Example 1 and Reference Example 2, the molar ratio of the lithium salt to the nonaqueous solvent was LiFSA:DMC=1:1.1.

The separator in Reference Example 1 is a commercial glass fiber nonwoven fabric (GB-100R, manufactured by Advantec) and has an average thickness of 380 μm and a porosity of 84%.

The separators in Reference Examples 2 to 4 are the separator (A1).

All the following treatments were performed in an argon gas atmosphere.

The copper foil was cut into a circle having a diameter of 18 mm. The metallic lithium foil was cut into a circle having a diameter of 1 mm. The separator was cut into a circle having a diameter of 15 mm, and the electrolyte solution was caused to permeate into the separator. The negative electrode, the separator, and the positive electrode (the metallic lithium foil and the copper foil) were stacked and housed in an electrochemical measurement cell (TJ-AC, NIHON TOMUSERU CO., LTD.) to assemble a disc-type two-electrode cell.

The two-electrode cells of Reference Example 1 and Reference Example 2 were charged and discharged under the following conditions.
Test temperature: room temperature
Current density: 0.5 mAcm⁻²
Capacity: 1 mAhcm⁻² in the 1-5th cycles, 2 mAhcm⁻² in the 6-10th cycles, and 3 mAhcm⁻² in the 11-15th cycles
Voltage range: −0.5 V to 0.5 V

The charge-discharge curves of the two-electrode cells of Reference Example 1 and Reference Example 2 are shown in FIG. 1.

The two-electrode cell of Reference Example 1 was short-circuited in the seventh cycle. The short circuit of the two-electrode cell of Reference Example 1 was due to the generation and the growth of lithium dendrites on the electrode.

The two-electrode cell of Reference Example 2 was charged and discharged without any trouble until the 15th cycle.

The two-electrode cells of Reference Example 2, Reference Example 3, and Reference Example 4 were charged and discharged under the following conditions.
Test temperature: room temperature
Current density: 0.5 mAcm⁻²
Capacity: 3 mAhcm⁻²
Voltage range: −0.5 V to 0.5 V
Number of cycles: 67 cycles in Reference Example 2, and 100 cycles in Reference Example 3 and Reference Example 4

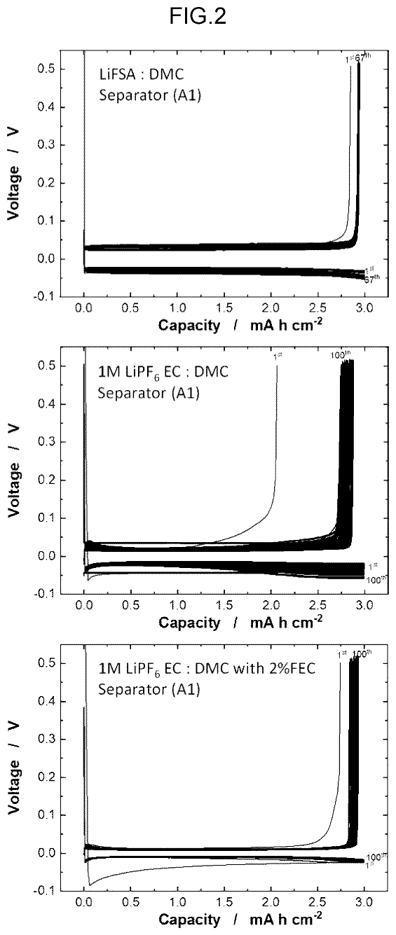

The charge-discharge curves of the two-electrode cells of Reference Example 2, Reference Example 3, and Reference Example 4 are shown in FIG. 2.

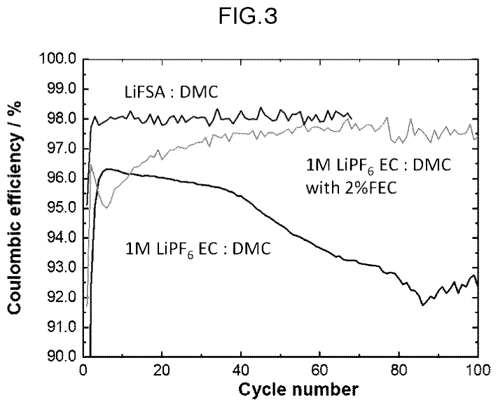

The cycle characteristics of the two-electrode cells of Reference Example 2, Reference Example 3, and Reference Example 4 are shown in FIG. 3.

As it can be seen from FIG. 3, in the two-electrode cell of Reference Example 2, the capacity is stable from the initial stage, and the cycle characteristics are excellent.

### Example 1 and Comparative Example 1

Two-electrode cells of Example 1 and Comparative Example 1 were produced. The forms of these two-electrode cells are as shown in Table 2.

TABLE 2

| | | Example 1 | Comparative Example 1 |
|---|---|---|---|
| Positive | Active Material | Li_{0.96}NiO₂ | Li_{0.96}NiO₂ |
| Electrode | Current Collector | Aluminum foil | Aluminum foil |
| Negative | Metallic Lithium Layer | Metallic lithium foil | Metallic lithium foil |
| Electrode | Current Collector | Copper foil | Copper foil |
| Electrolyte | Nonaqueous Solvent | DMC | EC:DMC |
| Solution | | | Volume ratio of 3:7 |
| | Lithium Salt | LiFSA | LiPF₆ |
| | Lithium Salt Concentration | 5.7 mol/L | 1.0 mol/L |

| | | |
|---|---|---|
| Separator | Separator (A1) | PP microporous film |

The positive electrode was produced as follows. All the following treatments were performed in an argon gas atmosphere, and the produced positive electrode was stored in an argon gas atmosphere until the production of the two-electrode cell.

Eighty parts by mass of a powder of lithium nickelate (Li_{0.96}NiO₂), 10 parts by mass of acetylene black, 10 parts by mass of polyvinylidene fluoride, and an appropriate amount of N-methyl-2-pyrrolidone were mixed with a mortar and a pestle to produce a positive electrode slurry. The positive electrode slurry was applied to one side of an aluminum foil, dried and then pressed to obtain a positive electrode having a positive electrode active material layer on one side.

The negative electrode is a metallic lithium foil.

In the electrolyte solution in Example 1, the molar ratio of the lithium salt to the nonaqueous solvent is LiFSA:DMC=1:1.1.

The separator in Example 1 is the separator (A1).

The separator in Comparative Example 1 is a commercial polypropylene microporous film and has an average thickness of 25 μm and a porosity of 55%.

All the following treatments were performed in an argon gas atmosphere.

The positive electrode was cut into a circle having a diameter of 10 mm. The metallic lithium foil for the negative electrode was cut into a circle having a diameter of 12 mm. The separator was cut into a circle having a diameter of 15 mm, and the electrolyte solution was caused to permeate into the separator. The negative electrode, the separator, and the positive electrode were stacked and housed in an electrochemical measurement cell (TJ-AC, NIHON TOMUSERU CO., LTD.) to assemble a disc-type two-electrode cell.

The two-electrode cells of Example 1 and Comparative Example 1 were charged and discharged under the following conditions.
Test temperature: room temperature
Charge-discharge rate: 50 mAg⁻¹
Voltage range: 2.5 V to 4.5 V
Number of cycles: 200 cycles in Example 1, and 100 cycles in Comparative Example 1

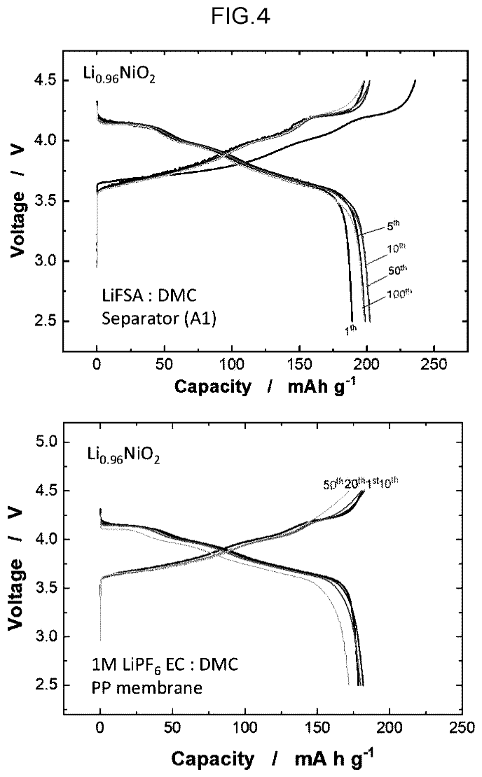

The charge-discharge curves of the two-electrode cells of Example 1 and Comparative Example 1 are shown in FIG. 4.

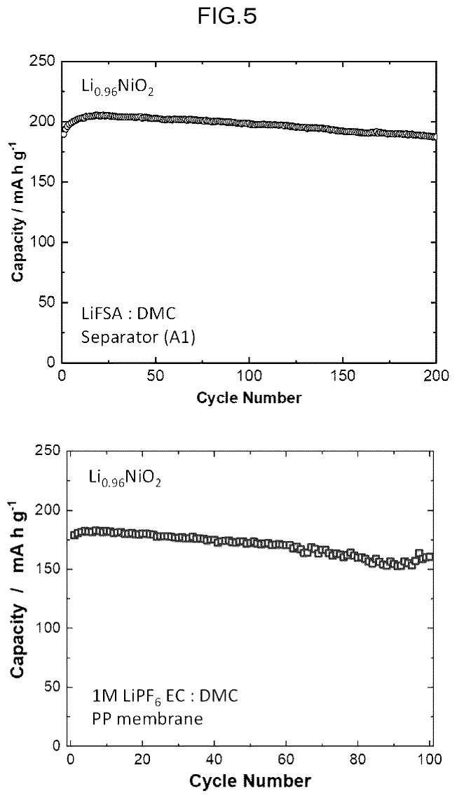

The cycle characteristics of the two-electrode cells of Example 1 and Comparative Example 1 are shown in FIG. 5.

As it can be seen from FIG. 5, the two-electrode cell of Example 1 is superior to the two-electrode cell of Comparative Example 1 in cycle characteristics.

### Example 2 and Comparative Example 2

Two-electrode cells of Example 2 and Comparative Example 2 were produced. The forms of these two-electrode cells are as shown in Table 3.

TABLE 3

| | | Example 2 | Comparative Example 2 |
|---|---|---|---|
| Positive | Active Material | Li_{1.1}Nb_{0.1}Mn_{0.8}O₂ | Li_{1.1}Nb_{0.1}Mn_{0.8}O₂ |
| Electrode | Current Collector | Aluminum foil | Aluminum foil |
| Negative | Metallic Lithium Layer | Metallic lithium foil | Metallic lithium foil |
| Electrode | Current Collector | Copper foil | Copper foil |
| Electrolyte | Nonaqueous Solvent | DMC | EC:DMC |
| Solution | | | Volume ratio of 3:7 |
| | Lithium Salt | LiFSA | LiPF₆ |
| | Lithium Salt Concentration | 5.7 mol/L | 1.0 mol/L |

| | | |
|---|---|---|
| Separator | Separator (A1) | PP microporous film |

The positive electrode was produced as follows. All the following treatments were performed in an argon gas atmosphere, and the produced positive electrode was stored in an argon gas atmosphere until the production of the two-electrode cell.

Eighty parts by mass of a powder of niobium-doped lithium molybdate (Li_{1.1}Nb_{0.1}Mn_{0.8}O₂), 10 parts by mass of acetylene black, 10 parts by mass of polyvinylidene fluoride, and an appropriate amount of N-methyl-2-pyrrolidone were mixed with a mortar and a pestle to produce a positive electrode slurry. The positive electrode slurry was applied to one side of an aluminum foil, dried and then pressed to obtain a positive electrode having a positive electrode active material layer on one side.

The negative electrode is a metallic lithium foil.

In the electrolyte solution in Example 2, the molar ratio of the lithium salt to the nonaqueous solvent is LiFSA:DMC=1:1.1.

The separator in Example 2 is the separator (A1).

The separator in Comparative Example 2 is a commercial polypropylene microporous film and has an average thickness of 25 μm and a porosity of 55%.

All the following treatments were performed in an argon gas atmosphere.

The positive electrode was cut into a circle having a diameter of 10 mm. The metallic lithium foil for the negative electrode was cut into a circle having a diameter of 12 mm. The separator was cut into a circle having a diameter of 15 mm, and the electrolyte solution was caused to permeate into the separator. The negative electrode, the separator, and the positive electrode were stacked and housed in an electrochemical measurement cell (TJ-AC, NIHON TOMUSERU CO., LTD.) to assemble a disc-type two-electrode cell.

The two-electrode cells of Example 2 and Comparative Example 2 were charged and discharged under the following conditions.
Test temperature: room temperature
Charge-discharge rate: 50 mAg⁻¹
Voltage range: 1.5 V to 4.8 V
Number of cycles: 40 cycles

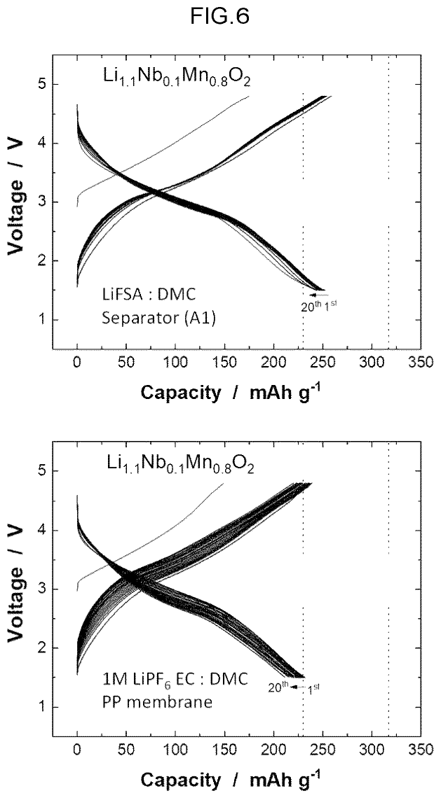

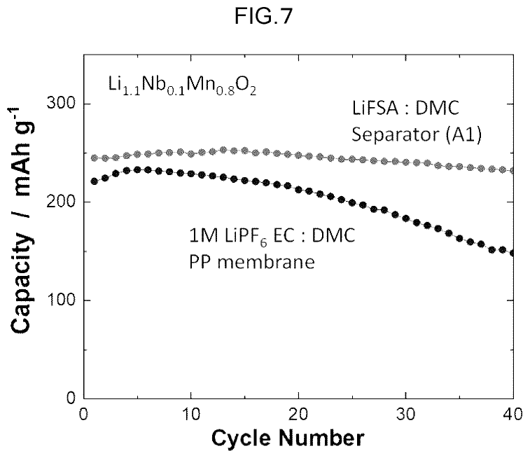

The charge-discharge curves of the two-electrode cells of Example 2 and Comparative Example 2 are shown in FIG. 6. The cycle characteristics of the two-electrode cells of Example 2 and Comparative Example 2 are shown in FIG. 7.

As it can be seen from FIG. 7, the two-electrode cell of Example 2 is superior to the two-electrode cell of Comparative Example 2 in cycle characteristics.

### Example 3 and Comparative Example 3

Two-electrode cells of Example 3 and Comparative Example 3 were produced. The forms of these two-electrode cells are as shown in Table 4.

TABLE 4

| | | Example 3 | Comparative Example 3 |
|---|---|---|---|
| Positive | Active Material | Li_{8/7}Ti_{2/7}V_{4/7}O₂ | Li_{8/7}Ti_{2/7}V_{4/7}O₂ |
| Electrode | Current Collector | Aluminum foil | Aluminum foil |
| Negative | Metallic Lithium Layer | Metallic lithium foil | Metallic lithium foil |
| Electrode | Current Collector | Copper foil | Copper foil |
| Electrolyte | Nonaqueous Solvent | DMC | EC:DMC |
| Solution | | | Volume ratio of 3:7 |
| | Lithium Salt | LiFSA | LiPF₆ |
| | Lithium Salt Concentration | 5.7 mol/L | 1.0 mol/L |

| | | |
|---|---|---|
| Separator | Separator (A1) | Glass fiber nonwoven fabric |

The positive electrode was produced as follows. All the following treatments were performed in an argon gas atmosphere, and the produced positive electrode was stored in an argon gas atmosphere until the production of the two-electrode cell.

Eighty parts by mass of a powder of titanium-doped lithium vanadate (Li_{8/7}Ti_{2/7}V_{4/7}O₂), 10 parts by mass of acetylene black, 10 parts by mass of polyvinylidene fluoride, and an appropriate amount of N-methyl-2-pyrrolidone were mixed with a mortar and a pestle to produce a positive electrode slurry. The positive electrode slurry was applied to one side of an aluminum foil, dried and then pressed to obtain a positive electrode having a positive electrode active material layer on one side.

The negative electrode is a metallic lithium foil.

In the electrolyte solution in Example 3, the molar ratio of the lithium salt to the nonaqueous solvent is LiFSA:DMC=1:1.1.

The separator in Example 3 is the separator (A1).

The separator in Comparative Example 3 is a commercial glass fiber nonwoven fabric (GB-100R, manufactured by Advantec) and has an average thickness of 380 μm and a porosity of 84%.

All the following treatments were performed in an argon gas atmosphere.

The positive electrode was cut into a circle having a diameter of 10 mm. The metallic lithium foil for the negative electrode was cut into a circle having a diameter of 12 mm. The separator was cut into a circle having a diameter of 15 mm, and the electrolyte solution was caused to permeate into the separator. The negative electrode, the separator, and the positive electrode were stacked and housed in an electrochemical measurement cell (TJ-AC, NIHON TOMUSERU CO., LTD.) to assemble a disc-type two-electrode cell.

The two-electrode cells of Example 3 and Comparative Example 3 were charged and discharged under the following conditions.
Test temperature: room temperature
Charge-discharge rate: 10 mAg⁻¹ or 30 mAg⁻¹
Voltage range: 1.2 V to 4.3 V
Number of cycles: 150 cycles in Example 3, and 50 cycles in Comparative Example 3

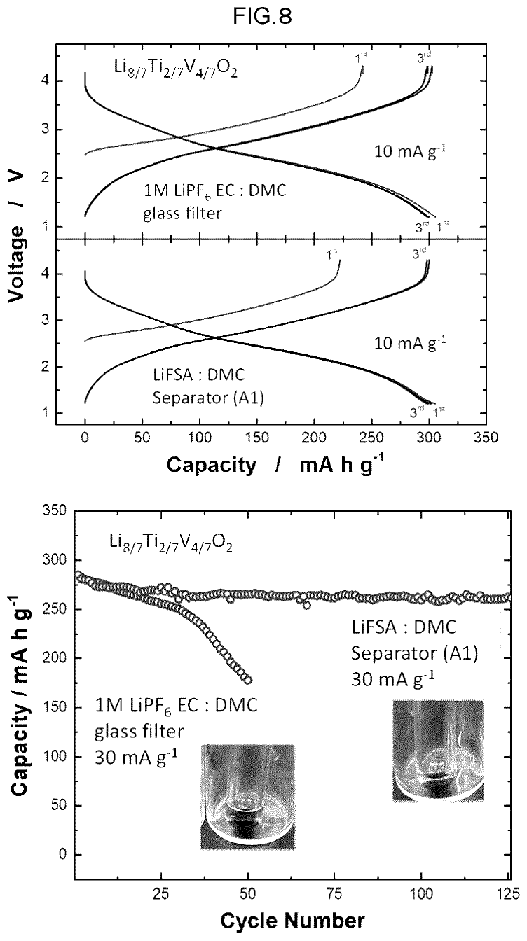

The charge-discharge curves and the cycle characteristics of the two-electrode cells of Example 3 and Comparative Example 3 are shown in FIG. 8.

As it can be seen from FIG. 8, the two-electrode cell of Example 3 is superior to the two-electrode cell of Comparative Example 3 in cycle characteristics.

In the charge-discharge test at a charge-discharge rate of 30 mAg⁻¹, the discharge capacity of the two-electrode cell of Comparative Example 3 was clearly lowered after 20 cycles, and thus the charge and discharge were completed after 50 cycles. Thereafter, the cell was disassembled to extract and observe the electrolyte solution, and as a result, the electrolyte solution was stained in green. It was presumed that vanadium was eluted from the positive electrode active material during charge and discharge.

After the charge-discharge test at a charge-discharge rate of 30 mAg⁻¹, the cell of Example 3 was disassembled to extract and observe the electrolyte solution, and as a result, the coloring of the electrolyte solution was not observed. In the two-electrode cell of Example 3, it is presumed that the transition metal in the positive electrode active material was not eluted because a high salt concentration electrolyte solution was used.

All the documents, patent applications, and technical standards described in this specification are incorporated in this specification by reference to the same extent as if each of the documents, the patent applications, and the technical standards were specifically and individually indicated to be incorporated herein by reference.

The disclosure of Japanese Patent Application No. 2022-175127 filed on Oct. 31, 2022 is incorporated in this specification by reference in its entirety.

1. A lithium secondary battery comprising:
a positive electrode;
a negative electrode that is operated by dissolution and precipitation of metallic lithium;
an electrolyte solution containing a nonaqueous solvent and a lithium salt and having a lithium salt concentration of 3.0 mol/L or more; and
a separator having a polyolefin microporous film and a porous layer provided on one side or both sides of the polyolefin microporous film and containing a wholly aromatic polyamide.

2. The lithium secondary battery according to claim 1, wherein the lithium salt contains at least one selected from the group consisting of a sulfonamide lithium salt and a sulfonimide lithium salt.

3. The lithium secondary battery according to claim 1, wherein the negative electrode has a metallic lithium layer.

4. The lithium secondary battery according to claim 1, wherein the negative electrode has a current collector in which metallic lithium is precipitated on a surface thereof.

5. The lithium secondary battery according to claim 3, wherein the positive electrode has an active material layer containing a lithium-containing active material that electrochemically dopes and dedopes lithium.

6. The lithium secondary battery according to claim 1, wherein the separator has the porous layer on both sides of the polyolefin microporous film.

7. The lithium secondary battery according to claim 1, wherein the wholly aromatic polyamide contains a meta-type wholly aromatic polyamide.

8. The lithium secondary battery according to claim 1, wherein the porous layer further contains inorganic particles.

9. The lithium secondary battery according to claim 8, wherein the inorganic particles contain metal sulfate particles.

10. The lithium secondary battery according to claim 8, wherein the average primary particle diameter of the inorganic particles is 0.3 μm or less.

11. The lithium secondary battery according to claim 4, wherein the positive electrode has an active material layer containing a lithium-containing active material that electrochemically dopes and dedopes lithium.

12. The lithium secondary battery according to claim 9, wherein the average primary particle diameter of the inorganic particles is 0.3 μm or less.
